(19) United States
(12) Patent Application Publication
(10) Pub. No.: US 2005/0095345 A1
(43) Pub. Date: May 5, 2005

(54) Soy products and soy product production methods and apparatus

(76) Inventors: John A. Schillinger, Cumming, IA (US); John William Colyn, Battle Creek, MI (US)

Correspondence Address: Hans I. Sun;Rider Bennett, LLP, Suite 2000, 333 South Seventh Street, Minneapolis, MN, 55402, US

(21) Appl. No.: 10/700,730

(22) Filed: Nov. 4, 2003

(51) Int. Cl. A23L 1/20

(52) U.S. Cl. 426/634

(57) ABSTRACT

Soy products having higher protein and natural soy oil content and methods and apparatus for producing high protein soy products from dehulled soybeans. The soy product contains at least five percent (5%) natural soy oil and at least forty percent (40%) protein in dry weight basis. The soy product is texturized and further contains over forty parts per million (40 ppm) tocopherols, over three percent (3%) isoflavones and over ten percent (10%) sugars. The protein content includes 11S and 7S protein in at least a 1.5:1 ratio. The methods include pressing dehulled soybeans to provide a pressed dehulled soybeans and grinding the pressed dehulled soybeans to provide soy flour. The soy flour is preprocessed to mix soy flour and water. The preprocessed soy flour is processed through an extruder to produce a soy product. A high protein soybean promotes texturization at high soy oil content levels. The shape and design of the extruder further promote texturization at high soy oil content levels.

The present invention generally relates to soy products and methods and apparatus for producing soy products. More particularly, the invention relates to soy products and methods and apparatus for producing high protein textured soy products having higher natural soy oil content.

### BACKGROUND OF THE INVENTION

Soy products are useful in many food applications. Soy flour and textured soy protein are used in products such as meat substitutes, in place of beef, pork, sausage and chicken. In these products, the soy product should carry a desired flavor, as well as have a pleasing texture. However, current soy flour processing techniques provide soy flours that have an inferior flavor and texture to these meat products.

Typical soy flour processing employs a process of dehulling, physical pressing, multiple chemical washes, and milling. This type of soy flour processing generally results in a soy flour having less than one percent (1%) oil, a result of the historical focus of the soy industry on maximizing oil extraction. The soy flour can then be further processed with an extruder to produce textured soy protein. These typical soy-processing methods require alcohol washings to remove oil in order to facilitate processing, as higher oil content lubricates the soy flour, therefore preventing the protein in the soy flour from texturizing. Thus, present soy product processing techniques, such as shown in U.S. Pat. No. 4,044,157, employ low soy oil flours.

While present soy product processing techniques require the removal of natural soy oil, natural soy oil has a number of desirable qualities. For example, natural soy oil includes antioxidants, a substance having numerous health benefits. Furthermore, soy products having low oil content, for example, below two percent (2%), tend to have a chalky texture. Soy products having higher content of natural soy oil can have an improved taste and better texture. Also, oil soluble flavors distribute better in a higher oil content product. Thus, there is a need for soy products and methods and apparatus for producing soy products containing a higher content of natural soy oil.

However, present methods of soy product production employ alcohol washings to remove the natural soy oil for processing. After dehulling and pressing, the resulting soy flakes generally have an oil content above four percent (4%). The present methods of soy product processing then use alcohol washings to reduce the oil content below one percent (1%). The soy flake is then ground using a process called milling, to yield soy flour and processed through an extruder to yield textured soy protein. Typical extrusion processes for soy flour processing employ a single screw or twin-screw extruder. These extruders include conveying and cooking screws, venturi or other process constrictions, and dies configured in a manner that allow protein in the soy flour to bond, a process known as fibration. The fibration provides much of the texture of the final soy product. Higher oil content, such as present prior to alcohol washings, lubricates the soy flour, preventing fibration. Therefore, present processes for textured soy protein product production remove natural soy oil prior to processing with the extruder in order to facilitate fibration.

Thus, despite the advantages of natural soy oil, present soy processing methods employ soy flour having low natural soy oil content. Furthermore, removal of natural soy oil requires additional processing steps, such as alcohol washings and subsequent denaturing, and therefore additional expense. There is therefore a need for methods and apparatus allowing for production of soy products from soy flour having a high content of original, natural soy oil without the use of alcohol washings.

Present soy processing methods provide a soy product from soy flour having about forty-five percent (45%) to fifty-three percent (53%) protein in dry basis and less than two percent (2%) oil in dry basis. A soy product from soy flour having protein content in dry basis of forty-eight percent (48%) to sixty percent (60%) or above and oil content of five percent (5%) to eleven percent (11%) can provide better nutritional qualities, better fibration and better texture. There is therefore a further need for soy products and methods and apparatus for providing a soy product from soy flour having at least forty-eight percent (48%) protein in dry basis and at least five percent (5%) original, natural soy oil in dry basis.

### SUMMARY OF THE INVENTION

The present invention solves these and other problems in the field of soy product production methods and apparatus by providing, in most preferred aspects, soy products having high protein and high natural soy oil content and methods and apparatus for producing high protein soy products from dehulled soybeans. The soy product includes over fifty percent (50%) protein and over five percent (5%) of original, natural soy oil. The soy product further includes over five percent (5%) sulfur bearing amino acids and above forty parts per million of tocopherols. The methods include pressing dehulled soybeans to provide a pressed dehulled soybeans and grinding the pressed dehulled soybeans to provide soy flour. The soy flour is preconditioned by mixing soy flour and water to obtain partially cooked soy flour. The soy flour is processed through an extruder to produce a textured soy product. A high protein content promotes texturization at high soy oil content levels. The shape and design of the extruder further promotes texturization at high soy oil content levels.

It is therefore an object of the present invention to provide soy products and novel methods and apparatus to produce soy products containing a higher content of natural soy oil.

It is therefore another object of the present invention to provide such novel methods and apparatus for production of soy products from soy flour having a high content of natural soy oil without the use of alcohol washings.

It is therefore a further object of the present invention to provide such novel methods and apparatus to produce a soy product from soy flour having at least forty-eight percent (48%) protein in dry basis and at least five percent (5%) oil in dry basis.

It is therefore a further object of the present invention to provide such novel methods and apparatus to promote texturization of soy products.

It is therefore a further object of the present invention to provide such novel methods and apparatus having adjustable retention time to provide for a desired level of fibration.

These and further objects and advantages of the present invention will become clearer in light of the following detailed description of an illustrative embodiment of this invention described in connection with the drawings.

### BRIEF DESCRIPTION OF THE DRAWINGS

The illustrative embodiment may best be described by reference to the accompanying drawings where:

FIG. 1 shows a perspective view of an extruder for producing soy products according to the preferred teachings of the present invention, with portions of the extruder structure removed to show details of the structure of the extruder.

FIGS. 2-4 show end views of die plates according to the preferred teachings of the present invention.

FIGS. 5 and 6 show perspective views of alternative embodiments of an extruder for producing soy products according to the preferred teachings of the present invention, with portions of the extruder structure removed to show details of the structure of the extruder.

All figures are drawn for ease of explanation of the basic teachings of the present invention only; the extensions of the figures with respect to number, position, relationship, and dimensions of the parts to form the preferred embodiment will be explained or will be within the skill of the art after the following description has been read and understood. Further, the exact measurements and measurement proportions to conform to specific percentages, sizes, and similar requirements will likewise be within the skill of the art after the following description has been read and understood. Values provided are representative and are utilized to facilitate the description of the preferred embodiment.

Where used in the various figures of the drawings, the same numerals designate the same or similar parts. Furthermore, when the terms “upper,” “lower,” “side,” “end,” “bottom,” “first,” “second,” “laterally,” “longitudinally,” “row,” “column,” “array,” and similar terms are used herein, it should be understood that these terms have reference only to the structure shown in the drawings as it would appear to a person viewing the drawings and are utilized only to facilitate describing the illustrative embodiment.

### DETAILED DESCRIPTION OF THE PREFERRED EMBODIMENT

The present invention provides soy products having higher protein and natural soy oil content and methods and apparatus for producing soy products having higher protein and natural soy oil content. In the method of the invention, attributes of a soybean variety allow for soy products having selected characteristics. Selection of a soybean variety having particular attributes allow for use of different techniques during processing. In the preferred embodiment of the invention, production of soy products makes use of a soybean variety having a high protein content, such as 290 F.HP or 240 F.Y., both available from Schillinger Seed, located in West Des Moines, Iowa. In other aspects of the present invention, the soy product production method employs soybean varieties having a high ratio of 11S to 7S protein. 11S storage protein has a unique physical structure and amino acid content in comparison to 7S protein. It is higher in sulfur bearing amino acids such as lysine, methionine, cystiene and tryptophan. The structure and amino acid arrangement and content of the 11S protein enhances fibration and lamination of the protein fibers. Most soybean varieties have ratios of 11S to 7S protein around 1.1:1. A ratio above 1.5:1 is considered high. The 290 F.HP (49-52% protein dry basis, 1.9:1 ratio), the 240F.Y. (45-47% Protein dry basis, 1.6:1 ratio 11S to 7S protein), both available from Schillinger Seed and X790 (47-49% protein dry basis, 1.6:1 ratio 11S to 7S protein), available from H.D.C. Cooperative, located in Hensall, ON, Canada, are examples of soybean varieties having a high ratio of 11S to 7S protein. Table 1 shows analysis of the content of example soybean varieties having high 11S to 7S protein varieties.

TABLE 1

| | Food Grade | | |
|---|---|---|---|
| | Typical | 290F.HP | |
| Traits | Checks | 2001 | 2002 |
| Protein-DWB | 42.0 | 48.4 | 50.4 |
| Oil | 21.1 | 18.7 | 17.9 |
| Total Sugars | 9.5 | 9.4 | 9.4 |
| Sucrose | 4.9 | 5.0 | 4.4 |
| Raffino Stachyose | 4.5 | 4.3 | 5.0 |
| Total Isoflavones | 1626 | 1082 | 1516 |
| Key Amino Acids | | | |
| Lysine | 2.49 | 2.81 | 2.91 |
| Cystiene | 0.55 | 0.62 | 0.64 |
| Methionine | 0.50 | 0.56 | 0.58 |
| Tryptophan | 0.48 | 0.54 | 0.55 |
| Total Key AA | 4.02 | 4.53 | 4.68 |
| % of Typical | 100 | 113 | 116 |
| Trypsin Inhibitor TIU/mg | — | 39.0 | 39.6 |
| Key Storage Protein | | | |
| 11S | — | | 47.6 |
| 7S | — | | 25.2 |
| Ratio 11S:7S | — | | 1.89 |
| Hila Color | — | B1 | B1 |
| % Yield Potential | 98 | 94 | 94 |
| Phytophthora | — | Rps₁^{a} | Rps₁^{a} |
| Cyst Nematode | S | S | S |
| Relative Seed Size (seeds/lb.) | 2400 | 2250 | 2200 |

Food Grade Typical Checks values obtained by testing A2247 from Asgrow and IA2025 and IA3001 from Iowa State University.

Hila Color: Bl=black; Y=yellow; IB-Imperfect black.

As shown by Table 1, flour from the F.HP soy variety can be used with the methods of the present invention to produce a soy product having over four point five percent (4.5%) of the key amino acids lysine, cystiene, methionine and tryptophan, compared to typical soy products that generally have four percent (4%) of these key amino acids. These key amino acids are sulfur bearing amino acids.

Production of soy products generally makes use of dehulled soybeans. The dehulled soybeans then undergo physical pressing to remove water moisture and oil to produce soybean cake. In one preferred embodiment of the invention, the soybean cake has an oil content of at least four percent (4%) after physical pressing.

In the preferred form of the present invention, the pressed soybean cake is milled directly after pressing without the use of alcohol washing. Milling of the soybean cake produces soy flour. Typical milling ranges from a coarse grind meal of most between 40-100 USSSS Screen mesh granulation, where a typical particle passes through a mesh of one-fortieth to one-one hundredth of an inch, to a fine flour grind of most through 100 USSSS Screen mesh, where a typical particle passes through a mesh of one-one hundredth of an inch. In the preferred form of the invention, a fine flour grind is employed. The fine grind allows for more thorough and quicker cooking of the soy protein in the preconditioner and extruder, and the delivery of a more consistent product having uniform fibration.

In the preferred form of the invention, production of soy flour without alcohol washing produces a soy flour having a natural soy oil content over five percent (5%) and a protein content of at least fifty percent (50%) in dry basis. Table 2 illustrates example contents of typical soy flours used in twin-screw extrusions in comparison with the soy flour of the present invention.

TABLE 2

| | PROCON | SS-53-LF |
|---|---|---|
| Protein | 67% | 55% Dry Weight |
| Oil | 0.9% | 9.1% |
| Tocopherols | 0% | 47.6 PPM (.0476%) |
| Isoflavones | 0% | 3460 PPM (3.460%) |
| Sugars | 0.3% | 11.4% |

Table 2 provides tested values for PROCON, a soy protein concentrate available from Central Soya Company, Inc., located in Fort Wayne, Ind., and SS-53-LF, a soy flour available from Heartland Fields, LLC, located in West Des Moines, Iowa. As illustrated in Table 2, soy flour production removes tocopherols and isoflavones from the soy flour and leaves low amounts of the original, natural soy oil, generally around one percent (1%) in dry weight basis.

As shown in Table 3, in one example embodiment, soy flour from 290 F.HP can be used to produce a soy product having over fifty-seven percent (57%) protein, over five percent (5%) natural, original soy oil, and over 40 ppm (parts per million) tocopherols. In further aspects of the present invention, the soy product may have over three percent (3%) isoflavones and over eleven percent (11%) sugars. In another embodiment of the invention, soy flour from 240 F.Y. can be used to produce a soy product having over fifty-two percent (52%) protein, over five percent (5%) natural, original soy oil, and over 40 ppm (parts per million) tocopherols. In another embodiment of the invention, soy flour from 240 X790 can be used to produce a soy product having over fifty-five percent (55%) protein, over five percent (5%) natural, original soy oil, and over 40 ppm (parts per million) tocopherols. Those skilled in the art will appreciate that different levels of protein, soy oil, tocopherols, isoflavones and sugars can be obtained using the methods of the invention. By way of example and not limitation, physical pressing may provide for a soy flour having seven percent (7%) or nine percent (9%) natural, original soy oil.

TABLE 3

| | 290 F. HP | X790 |
|---|---|---|
| Protein | 57-60% | 55-57% |
| Oil | 5-11% | 5-11% |
| Tocopherols | Above 40 ppm | Above 40 ppm |

In the preferred form of the present invention, after milling, the soy flour is preconditioned prior to processing through the extruder. During preconditioning, water and soy flour are mixed. With higher soy oil content flour, preconditioner speeds of approximately 100 rpms, used by many processing methods, results in uneven mixing and uneven cooking in the extruder. This results in delivery of flour to the extruder that includes flour balls, where the inside of a flour ball is dry and the outside is wet.

Preconditioning provides a means of handling energy transfer into the soy flour. Preconditioning may be accomplished using commercially available units, such as the DDC Preconditioner, available from Wenger Manufacturing, located in Sabetha, Kans. However, the higher soy oil content flour has different energy characteristics than typical soy flour, requiring higher levels of energy input and specialized treatment.

The present invention provides preconditioning methods for transfer of energy into a high soy oil content flour. In most preferred aspects, the water mixed into the soy flour comprises both steam and liquid in a 1:1 ratio. In other aspects of the invention, the flour to water ratio ranges from 2.5:1 to 5:1. As those skilled in the art will understand, other flour to water ratios and other steam to liquid ratios may be employed without departing from the spirit or scope of the invention. In one example embodiment of the present invention, a preconditioner mixes the soy flour and water in a 3:1 ratio, at speeds above 400 rpms, in order to provide sufficient fluidity inside the preconditioner to partially cook the soy flour. Partial cooking of the soy flour includes providing for uniform hydration in order to deliver well-conditioned flour to the extruder.

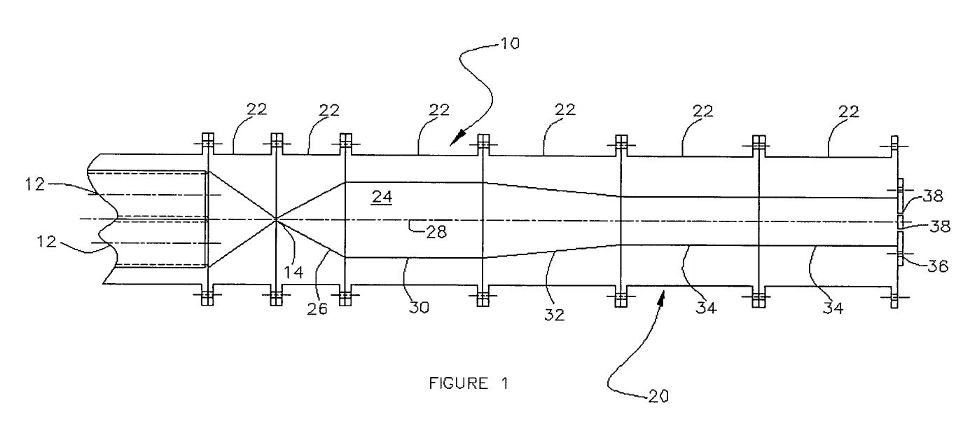

The preconditioned mixture of water and soy flour then enters the extruder. In one preferred embodiment, the extruder is a twin-screw extruder 10 as shown in FIG. 1. Other extruders, such as a single screw extruder, can also be employed. The extruder screws 12 transports the preconditioned mixture to a venturi 14. The venturi 14 provides restriction to the flow of the preconditioned mixture, building up backpressure in the extruder 10 prior to the venturi 14. A typical level of backpressure in the extruder is 1800-2000 p.s.i. The backpressure prevents the extruder screws 12 from acting as a simple conveyor, and serves to allow the extruder screws 12 to impart mechanical energy to the preconditioned mixture. Thus, the transport by extruder screws 12 serves to further mix and cook the preconditioned mixture. The present invention advantageously provides for a more constricted venturi 14 due to the lubricating effect of the high level of soy oil. In the example embodiment, the venturi 14 is a one eighth inch (⅛″) opening. This restricted passage through the venturi 14 also helps ensure complete cooking of the preconditioned mixture, so that the preconditioned and extruded flour passing through the venturi 14 is uniformly cooked to provide a cooked flour mass.

In the preferred embodiment, the cooked flour mass passes through the venturi 14 into a die assembly 20. In this embodiment, the die assembly 20 includes a series of cylindrical extensions 22 affixed to the extruder 10 to shape and direct the pattern of flow within the die assembly 20 of the extruder 10. The interior of the die assembly 20 is a fibration chamber 24. The die assembly 20 and the fibration chamber 24 can be modified by using different extensions 22 to increase and decrease the retention time of the cooked flour mass within the extruder 10 to produce a soy product having a desired texturization. For a higher level of texturization and fibrosity, the die assembly 20 can be modified to increase retention time by increasing the volume of the fibration chamber 24. Conversely, for lower levels of texturization and fibrosity, the volume of the fibration chamber 24 can be decreased to reduce retention times. Likewise, the rate of flow of the cooked flour mass may be adjusted to modify texturization and fibrosity.

In a first example embodiment, a first section of the fibration chamber 24 is an expansion section 26 having an increasing cross section with respect to an axis of flow 28, with the diameter of the fibration chamber 24 increasing from the one eighth inch (⅛″) venturi 14 to three point five inches (3½″) over a length of three inches (3″). In the example embodiment, the cooked flour mass follows a straight line of flow through the die assembly 20. The straight line of flow, along with the shape of the fibration chamber 24, is designed to minimize turbulence, thereby promoting fibration. The straight line of flow further promotes formation of strands of protein fiber that mimic muscle fibers, as opposed to a branching or gnarled structure. Because of the increase in diameter of the fibration chamber 24, the cooked flour mass slows, during passage into the expansion section 26 providing additional time for protein fibers in the cooked flour mass to align. The cooked flour mass continues through the expansion section 26 into a constant diameter section 30. In the example embodiment, the constant diameter section 30 has a diameter of three point five inches (3½″) and a length of six inches (6″).

In the example embodiment, the preconditioned mixture then passes into a compression section 32. The compression section 32 has a decreasing cross section with respect to the axis of flow 28, decreasing from a diameter of three point five inches (3½″) to two point two five inches (2¼″), over a length of six inches (6″). The reduced diameter of the compression section 32 increases the speed of the preconditioned mixture through the die assembly 20. The length of the compression section 32 allows for a gradual increase in speed to reduce turbulence. A pressure gradient exists along the axis of flow 28 through the fibration chamber 24. The cooked flour mass then passes into a constant diameter tube 34. The constant diameter tube 34 allows for further aligning and binding together of the protein fragments during travel through the constant diameter tube 34. In this example embodiment, the constant diameter tube 34 maintains a diameter of two point two five inches (2¼″) and has a length of twelve inches (12″). The linkages formed with the protein fragments provide for the uniquely structured high protein textured soy product.

Variation in the volume of the fibration chamber 24 allows for different retention times given a constant rate of extrusion with a selected extruder. In one aspect of the invention, turbulence is minimized by designing the surface of the fibration chamber 24 to have a low coefficient of drag, providing for smooth flow of the preconditioned mixture through the venturi 14. In one example embodiment, the surface of the die assembly 20 can have a Teflon® coating. In a second example embodiment, the interior surface of the die assembly 20 can be a polished steel surface.

The die assembly 20 terminates in a die plate 36 having one or more openings 38. The soy product is extruded from the die plate openings 38. In the preferred embodiment, the fibration chamber 24 narrows to ease the transition at the die plate 36 and provide a minimum of turbulence. In this example embodiment, the diameter of the constant diameter tube 34 is selected to match a desired conformation of the die plate openings 38.

The fibration chamber 24, in this example embodiment of the invention, includes a volume of 145 cubic inches. Experimentation demonstrates that a feed rate of 360 kg/hr of the cooked flour mass into the extruder assembly 10 in this embodiment produces a soy product having desirable fibration and texturization. The relative retention of the cooked flour mass in the fibration chamber 24 is 0.403 cubic inches per kg per hour at this feed rate. The throughput of the cooked flour mass in the fibration chamber 24 is 152 kilograms per hour per liter.

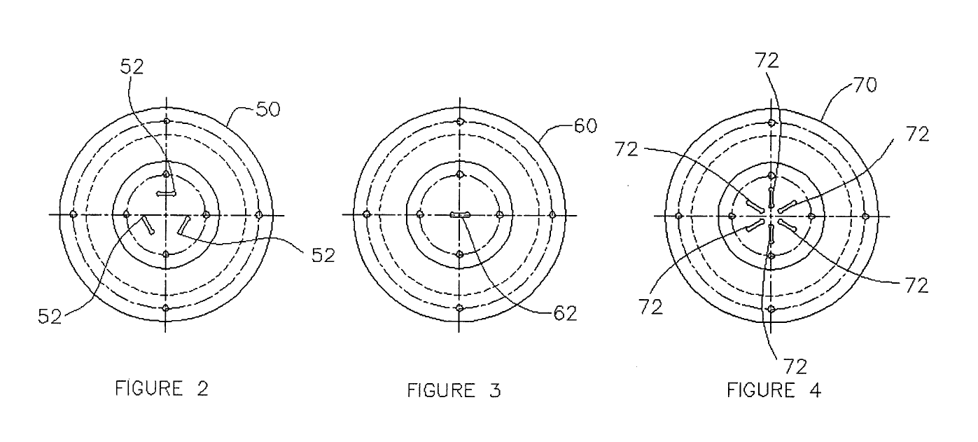

FIG. 2 shows a die plate 50 according to the preferred teachings of the present invention, having three openings 52 equidistantly spaced from each other and from the center of the die plate 50. In one embodiment, the openings 52 comprise slots of one-eighth inch (⅛″) by three-fourths inch (¾″). After extrusion through the die plate 50, the soy product may be cut as it is extruded. Alternatively, pulling or other techniques can be employed to remove the soy product.

FIG. 3 shows an alternative embodiment of a die plate 60 according to the preferred teachings of the present invention. This die plate 60 has a single slot 62 on the center of the die plate 60. FIG. 4 shows another alternative embodiment of a die plate 70 according to the preferred teachings of the present invention. This die plate 70 has six slots 72 equidistantly spaced from each other and from the center of the die plate 70. The die plate 60 of FIG. 3 can be used for lower volume applications, while the die plate 70 of FIG. 4 can be used for high volume applications.

As those skilled in the art will appreciate, the extruder assembly 10 may include other dimensions without departing from the spirit or scope of the invention. In one alternate embodiment, the dimensions of the extruder assembly 10 may be scaled up to provide for increased production. For example, the method of the invention includes increasing retention time of the soy flour within the extruder 10 by either lengthening or widening the fibration chamber 24. Throughput can be increased by scaling up by a factor of three, while modifying the shape of the extruder assembly 10 to maintain retention time and flow pattern of the soy flour. Likewise, other numbers of die plate openings 52, 72 and die plate configurations 50, 70 can be employed without departing from the spirit or scope of the invention.

The methods and apparatus for soy product production of the invention further include providing various texturizations and fiber development of the soy product. These texturizations and fiber development can be accomplished by varying conditions in processing. A highly texturized soy product can be produced in accordance with the teachings of the present invention either by: using a high protein soy flour, increasing time in the fibration chamber 24, or both. A less dense, or less textured soy, product can be produced by using: a lower protein soy flour with forty-five percent (45%) to forty-eight percent (48%) protein and five percent (5%) to eleven percent (11%) oil, decreasing time in the fibration chamber 24, or both. In most preferred aspects of the invention, using soy flour having higher levels of natural soy oil, particularly for oil-based flavorings, may enhance flavoring the soy product. Alternatively, use of soy flours having high levels of natural soy oil may obviate the need for additional flavorings in certain applications.

In most preferred forms, the configuration of the extruder assembly 10 provides for considerations such as power levels and structural integrity. For example, an extruder assembly 10 having a large volume or lengthy travel requires high levels of power for operation. Poor design constraints may result in damage to the extruder assembly 10.

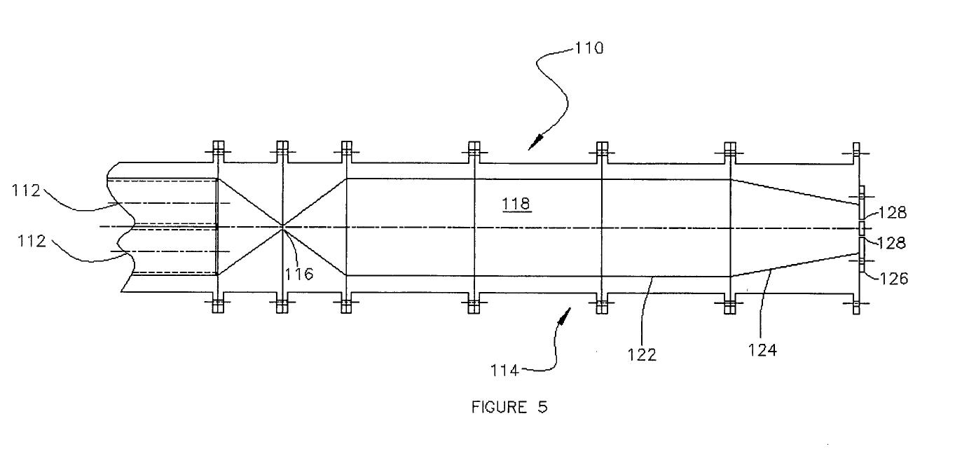

FIG. 5 shows a second example embodiment of the extruder assembly 110 of the invention. In this example embodiment, extruder screws 112 feed the cooked flour mass into the die assembly 114 through a one-quarter inch (¼″) venturi 116. The venturi 116 leads to a fibration chamber 118 beginning with an expansion section 120 three inches (3″) long and expanding to a diameter of four point five inches (4½″). The next component of the fibration chamber 118 is a constant diameter tube 122 of four point five inches (4½″) diameter and fifteen inches (15″) long. This constant diameter tube 122 then feeds into a compression section 124 eight inches (6″) long and compressing to a diameter of 3.5″. The fibration chamber 118 ends in a die plate 126 through which the extruder assembly 110 extrudes the soy product.

This embodiment of the extruder assembly 110 of the invention includes a fibration chamber 118 having a volume of 265 cubic inches. Having a larger fibration chamber 118, the extruder assembly 110 as shown in FIG. 5 has increased production relative to the extruder assembly 10 as shown in FIG. 1, while maintaining similar average retention times. With a feed rate of 650 kg/hr, the cooked flour mass has a throughput of 150 kg/Hr/L within the fibration chamber 118 using a die plate 70 as shown in FIG. 4. Experimentation demonstrates that this results in a well-textured soy product. The relative retention of the cooked flour mass at the feed rate of 650 kg/hr within the fibration chamber 118 is 0.408 cubic inches per kg per hour. Experimentation further demonstrated that a feed rate of 575 kg/hr resulted in a more tightly fibered product, and a feed rate of 725 kg/hr resulted in a less fibrous structured product, using this configuration. The relative retention of the cooked flour mass at the feed rate of 575 kg/hr within the fibration chamber 118 is 0.461 cubic inches per kg per hour, and the relative retention of the cooked flour mass at the feed rate of 725 kg/hr is 0.366 cubic inches per kg per hour. The extruder assembly 110 as shown in FIG. 5 can be used in applications requiring a higher throughput than the extruder assembly 10 shown in FIG. 1.

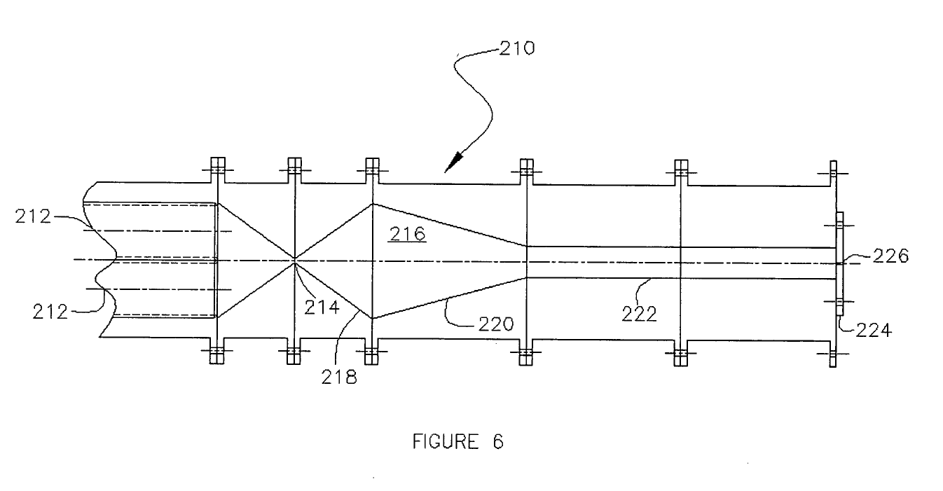

FIG. 6 shows a third example embodiment of the extruder assembly 210 of the invention. Extruder screws 212 feed the cooked flour mass through a one-eighth inch (⅛″) venturi 214. The venturi 214 leads into a fibration chamber 216 beginning with an expansion section 218 three inches (3″) long expanding to a diameter of four point five inches (4½″). Flow continues into a compression section 220 six inches (6″) long and compressing to a diameter of one point two five inches (1¼″). Flow continues through a constant diameter tube 222 twelve inches (12″) long and having a diameter of one point two five inches (1¼″). The fibration chamber ends 216 in a die plate 224. The extruder assembly 210 extrudes the soy product through a slot 226.

This embodiment of the extruder assembly 210 of the invention includes a fibration chamber 216 having a volume of 50 cubic inches. With a feed rate of 120 kg/hr, the cooked flour mass has a throughput of 146 kg/hr/L, within the fibration chamber 216, using a die plate 60 as shown in FIG. 3. The relative retention of the cooked flour mass in the fibration chamber 216 is 0.417 cubic inches per kg per hour at this feed rate.

As the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A method for producing soy products comprising:
pressing dehulled soybeans to provide pressed soy flakes;
milling the pressed soy flakes to provide soy flour;
preconditioning the soy flour with water to provide a preconditioned mixture; and
processing the preconditioned mixture through an extruder to produce a high protein textured soy product.

2. The method of claim 1 with milling the pressed soy flakes to provide soy flour further comprising milling the pressed soy flakes to provide soy flour having at least five percent (5%) natural soy oil content.

3. The method of claim 1 with milling the pressed soy flakes to provide soy flour further comprising milling the pressed soy flakes to provide pressed soy flour having at least a forty (40%) percent protein in dry basis.

4. The method of claim 1 with milling the pressed soy flakes to provide soy flour further comprising milling the soy flakes to provide soy flour having a ratio of 11S protein to 7S protein of at least 1.5:1.

5. The method of claim 1 with milling the pressed soy flakes to provide soy flour further comprises milling the pressed soy flakes into a fine flour grind of most through 100 USSSS Screen mesh.

6. The method of claim 1 with processing the preconditioned mixture through an extruder further comprising processing the preconditioned mixture through a twin screw extruder.

7. The method of claim 1 with preconditioning the soy flour to provide a preconditioned mixture further comprises mixing the soy flour with water in steam state and liquid state, where the water adds energy to the soy flour and partially cooks the soy flour to provide the preconditioned mixture.

8 The method of claim 7 with preconditioning the soy flour with water further comprises mixing the soy flour and water with paddles at a speed of at least 400 rpms to provide a preconditioned mixture.

9. The method of claim 1 with processing the preconditioned mixture through an extruder to produce a high protein soy product further comprising:
transporting the preconditioned mixture with a transport mechanism through the extruder to a fibration chamber;
restricting flow into the fibration chamber with a venturi to create backpressure and allow the transport mechanism to further mix and cook the preconditioned mixture to provide a cooked flour mass to the fibration chamber;
transporting the cooked flour mass through the fibration chamber to provide for fibration of the cooked flour mass to provide a fibrated mass, with the Vibration chamber having a shape designed to promote fibration of the cooked flour mass in strands and a volume designed to provide a selected relative retention time given a predetermined feed rate of the preconditioned mixture, and with the cooked flour mass following a straight line of flow to promote fibration of the cooked flour mass in strands; and
extruding the fibrated mass from the fibration chamber to provide a soy product.

10. The method of claim 9 with the venturi sized to restrict flow of the preconditioned mixture into the fibration chamber to allow for sufficient mixing and energy to provide a uniformly cooked flour mass to the fibration chamber.

11. The method of claim 9 further comprising adjusting the predetermined feed rate into the extruder to adjust the relative retention time within the fibration chamber.

12. The method of claim 9 further comprising adjusting the volume and the shape of the fibration chamber to adjust the relative retention time within the fibration chamber.

13. The method of claim 9 with the selected relative retention time within the fibration chamber being 0.39 to 0.43 cubic inches per kg per hour.

14. The method of claim 9 with the fibration chamber having an inner surface having a low coefficient of friction to reduce turbulence in the flow of the cooked flour mass through the die assembly

15. A texturized and fibrated soy product comprising:
forty percent (40%) to sixty-three percent (63%) soy protein content in dry weight basis; and
five percent (5%) to eleven percent (11%) original, natural soy oil in dry weight basis.

16. The texturized and fibrated soy product of claim 15 further comprising at least forty parts per million (40 ppm) tocopherols.

17. The texturized and fibrated soy product of claim 15 further comprising at least three percent (3%) isoflavones.

18. The texturized and fibrated soy product of claim 15 further comprising at least ten percent (10%) sugars.

19. The texturized and fibrated soy product of claim 15 with the soy protein content of the soy product further comprising 11S and 7S protein in a ratio of at least 1.5:1.

20. A texturized and fibrated soy product produced from soy flour, with the soy flour comprising:
from forty percent (40%) to sixty-three percent (63%) soy protein content in dry weight basis; and
from five percent (5%) to eleven percent (11%) original, natural soy oil.

21. The texturized and fibrated soy product of claim 20 with soy protein content of the soy flour further comprising 11s and 7s protein in a ratio of at least 1.5:1.
